(19) United States
(12) Patent Application Publication
(10) Pub. No.: US 2005/0284566 A1
(43) Pub. Date: Dec. 29, 2005

(54) Method and facility for bubble-free and inclusion-free labeling of foil labels

(76) Inventors: Michael Wagner, Kulmbach (DE); Hans-Heinrich Topfer, Kulmbach (DE)

Correspondence Address: BARNES & THORNBURG, 11 SOUTH MERIDIAN, INDIANAPOLIS, IN, 46204, US

(21) Appl. No.: 10/990,905

(22) Filed: Nov. 17, 2004

(30) Foreign Application Priority Data
Jun. 23, 2004 (DE) 10 2004 030 298.7

(51) Int. Cl. B29C 65/00

(52) U.S. Cl. 156/291; 156/556

(57) ABSTRACT

The invention pertains to a method for the labeling of a foil label onto an object, whereby on a first side, which in the labeled state forms the back, glue is applied in at least some regions and the label is subsequently applied by its first side onto the object. A film of liquid is applied in at least some regions between the first side and the object.

The present invention pertains to a method and a facility for labeling. Such labeling methods and facilities are needed everywhere where labels are applied to objects. The various labeling methods that are available in the state of the art are presented in “Handbuch der Etikettiertechnik [Handbook of Labeling Technology]” (publisher J. Bückle, D. Leykamm, 6th Edition, 2001), for example.

At the present time, it is not only labels made of paper that are being used, but foil labels made of plastic, e.g., transparent, opaque or metallized foil labels, are increasingly being used as well. They are processed in the form of individual labels, in a punched and/or cut version, or also from the roll. The present invention relates to such foil labels in all of their various forms.

Transparent foil labels are primarily processed as pressure-sensitive adhesive labels (no-label look). For cost reasons and for the reusability of the containers, labels of this type should preferably be applied to objects or containers with a suitable glue, transparent, for example, using the present wet glue labeling technique.

What is disadvantageous about this, however, is the fact that in the case of transparent labels in particular, the adhesion of the label to the object does not take place in the optimum way, and bubbles and other kinds of inclusions impair the visual impression in a very serious way. For that reason, in the state of the art foil labels are applied in the form of self-adhesive labels. Attempts have been made to use the wet glue technique to apply these labels to the objects with an appropriate visual result, but so far without success.

Taking over at this point is the present invention, which makes available a labeling method for foil labels, by means of which a good visual result that is comparable to self-adhesive labels can be achieved, while avoiding or greatly decreasing the forming of bubbles between the label and the object.

This problem is solved through the method according to claim 1 as well as through the labeling facility according to claim 12. Advantageous further developments of the inventive method and the inventive labeling facility are indicated in the dependent claims.

The invention solves this problem in that immediately before the application of the, for example, wet glued foil label, a thin layer of liquid is applied by means of spraying or vaporization to the latter and/or to the object to which glue is to be applied. The layer can also be applied by means of other methods. If the label is now applied to the object, as a result of the film of moisture that has been applied a largely bubble-free and inclusion-free, visually appropriate labeling result is achieved. This visual state is retained.

Especially good results can be achieved when the glue pallet, which is being used and by means of which the label is taken from the magazine and glue is applied, exhibits recesses on the side facing the label, so that the transfer of glue onto the foil label takes place only partially. In that regard, the partial recesses can be adapted to the particular print decor in the transparent and/or imprinted regions of the foil label. By doing this, a saving of glue is brought about and, in particular, possible inclusions such as any remaining bubbles can be pressed out during the subsequent brushing on or rolling on of the label.

In the case of labeling facilities with a gluing pallet carousel, the application of the film of liquid takes place following the transfer of the glue-coated label from the glue pallet to the gripping carousel. The label is thus provided with the film of moisture, preferably a film of water, on the glue-coated side prior to application to the object. In addition or an alternative, the object itself, e.g., a bottle, can also be provided with the film of moisture prior to the application of the label. For this purpose, in the case of conventional labeling facilities the object can, for example, be provided with the film of liquid at a distance of less than one meter, advantageously at a distance of less than 0.5 m before the labeling, or less than one second, advantageously less than 0.5 seconds, advantageously less than 0.1 seconds, before the labeling, or also immediately upon the transfer of the labels to the object.

Moreover, the glue pallets can be configured in such a way that narrow channels run inward from the outside of the labels. These channels are used, first, for carrying away the liquid immediately following the labeling, and have an even greater importance in terms of the label removal required for reuse systems in order to reuse the object. That is because foil labels are generally impermeable to caustic solutions. The inventive channels now make it possible for the caustic solution to penetrate laterally behind the label and to loosen the label. In this connection, it is important to provide as few glue-coated regions as possible, which can take place as a result of the above-mentioned recesses in the glue pallet or the glue-coated regions of the label.

The foil labels are advantageously pressed onto the container by means of pressing sponges. In conjunction with that, the pressing sponges can advantageously exhibit a defined compression hardness of 2 kPa to 8 kPa.

The creation of the film of liquid on the container and/or the label can take place touch-free or contact-free, or also in contact with or touching the label and/or container. In the first case, the container or label can, for example, be contacted by vapor or sprayed with the liquid. For this purpose, in the inventive labeling facility a device for creating the film of liquid, e.g., a spray head or a vaporizing nozzle, can be provided in direct proximity before the transfer of the label to the container. For example, such a spray head or vaporizing nozzle can be placed in such a way that the labels grasped by the gripping device can be provided with the film of liquid. For this purpose, the spray head or vaporizing nozzle is to be placed opposite the gripping device between the transfer region of the labels from the glue pallet to the gripping device and the transfer region of the labels from the gripping device onto the container. In the same way, it is also possible to place the spray head or the vaporizing nozzle in such a way that the label and/or the container is provided with the film of moisture shortly before or directly during the transfer of the label to the container.

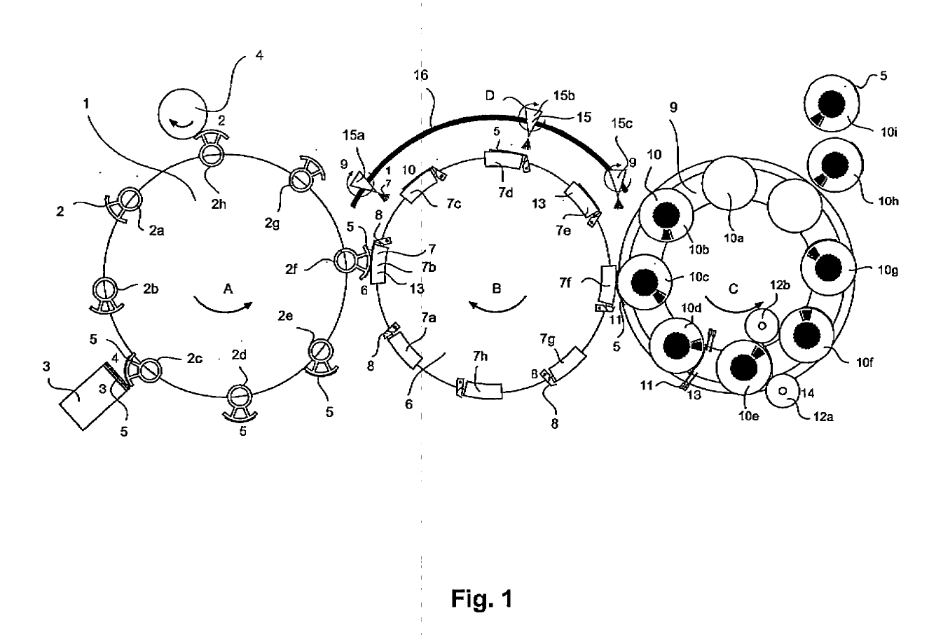

In the following, an example of an inventive labeling method and an inventive labeling facility is given. The latter is shown in the single FIG. 1.

Shown in FIG. 1 is a glue pallet carousel 1, a gripping carousel 6 and a container carousel 9, by means of which a label 5 from a label magazine 3 is applied to a container 10a through 10i.

The glue pallet carousel 1 exhibits at least one glue pallet 2. In FIG. 1, this glue pallet 2 is shown in a variety of positions 2a through 2h. In that regard, the glue pallet carousel 1 rotates in the direction of the arrow A and the glue pallet 2 also rotates independently around its axis of rotation.

Starting with position 2a, an already glue-coated glue pallet 2 is shown. This glue pallet is subsequently pivoted into position 2b and runs past a label magazine 3 in which separated, e.g., punched or cut foil labels 5, are stacked. The glue-coated region of the glue pallet 2 rolls onto the topmost label 5, which is lying in the label magazine 3 with its back facing upward, and thereby removes it. During the further rotation of the glue pallet carousel 1, the glue pallet 2 that has been provided with the label 5 is transported until it reaches a region in which it lies directly opposite the gripping carousel 6. The gripping carousel 6 exhibits at least one gripping device 7, which is shown here in its various positions 7a through 7h. In conjunction with that, the gripping carousel 6 rotates in the direction of the arrow B.

The individual gripping device 7 exhibits a gripping finger 8 with which a label 5 is securely clamped between a gripping support and the gripping finger 8.

In position 7b, the gripping device 7 takes the label, which is in position 2f, from the glue pallet 2. In this way, the label 5 is transported in the closed gripper with its back facing outward and lying on the pressing sponge.

The gripping carousel 6 now rotates until the gripping device lies in position 7f opposite the container carousel.

The container carousel 9 now transports containers 10, which are shown in their individual positions 10a through 10i, past the gripper in position 7f. In conjunction with that, the container carousel 9 rotates in the direction of the arrow C, and for their part, the containers 10 rotate around their own vertical axis.

The containers, now in position 10c, take from the gripping device in position 7f the label 5, which comes to lie with its glue side on the container 10.

Then, in position 10d, the label is pressed on by means of pressing brushes 11, and in position 10e the label is further pressed onto the container 10 by means of pressing rollers 12a and 12b. In position 10h, the labeled container leaves the labeling carousel 9.

What is now crucial, is that a moistening device 15 is placed in the region between the transfer of the label from the glue pallet 2 onto the gripping device 7 and the transfer of the label from the gripping device 7 onto the container 10. This moistening device 15 can be placed within the region in FIG. 1 that has been provided with reference symbol 16 and is shown in the form of a beam. Shown by way of example in FIG. 1 are three different positions 15a through 15c. The moistening device 15 in FIG. 1 is a spray device for applying a film of water to the glue-coated back of the label, which is being held by the gripping device 7. In that regard, the spray device 15 can be mounted so it can pivot or oscillate in the direction of the arrow D in order to cover the entire label 5 with the spray stream.

1. A method for the labeling of a foil label onto an object, whereby on a first side, which in the labeled state forms the back, glue is applied in at least some regions and the label is subsequently applied by its first side onto the object, wherein a film of liquid is applied in at least some regions between the first side and the object.

2. The method according to claim 1 wherein the film of liquid is one of sprayed on and vaporized on.

3. The method according to claim 1 wherein the liquid comprises at least one of a sprayable liquid, water and a vaporized medium.

4. The method according to claim 1 wherein the film of liquid is applied to the label between removal of the label from one of a label magazine and a roll and application of the label onto the object.

5. The method according to claim 1 wherein the film of liquid is applied to the label after the label has been taken from a glue pallet by a gripping device.

6. The method according to claim 1 wherein the film of liquid is applied to the object during the labeling process prior to the application of the label to the object.

7. The method according to claim 6 wherein the film of liquid is applied to the object≦1 second prior to the application of the label to the object.

8. The method according to claim 1 wherein glue is applied to the label only in some regions.

9. The method according to claim 8 wherein the glue is at least partially not applied to the label in at least one of transparent regions and imprinted regions.

10. The method according to claim 9 wherein glue is applied to the label in such a way that the glue layer comprises glue-free channels that form a passageway to the outside edge of the label.

11. The method according to claim 10 wherein the label is pressed onto the object by least one pressing sponge with a compression hardness of 2 kPa to 8 kPa inclusive.

12. A labeling facility for the labeling of containers, having at least one glue application device for applying glue to the back of the label, at least one gripping device for taking the glue-coated label from the glue application device and transfer of the label onto the container, wherein a device for creating a film of liquid on the glue-coated back of the label is placed in the region between the glue application device and the transfer of the label onto the container at at least one location along the path of movement of the gripping device.

13. The labeling facility according to claim 12 wherein the glue application device comprises a glue roller, and at least one glue pallet for holding the glue from the glue roller, removal of the label from the label holder and application of glue to the back of the label.

14. The labeling facility according to claim 12 comprising a pressing device for pressing the label onto the container.

15. The labeling facility according to claim 14 wherein the pressing device comprises a pressing sponge.

16. The labeling facility according to claim 15 wherein the pressing device comprises a pressing sponge with a compression hardness between 2 kPa to 8 kPa inclusive.

17. The labeling facility according to claim 16 further including at least one of a label holder designed as a stacked magazine and a holder for rolls of labels.

18. The labeling facility according to claim 13 wherein the glue pallets comprise recesses on the side holding the glue.

19. The labeling facility according to claim 12 wherein recesses are placed in such a way that glue is at least partially not applied to at least one of transparent regions of the label and imprinted regions of the label.

20. The labeling facility according to claim 18 wherein the recesses comprise the form of channels that form a passageway from at least one of the glue-coated locations and the non-glue coated locations to the outside edge of the label.

21. The labeling facility according to claim 20 wherein the channel-like recesses comprise a width ≧2 mm.

22. The labeling facility according to claim 12 wherein the device for applying a film of liquid comprises one of a spray head and a vaporizing nozzle.

23. Use of the method according to claim 1 for the labeling of objects with one of foil labels, foil labels with non-transparent regions foil labels with transparent regions, labels made of antistatic foil, foil labels with imprinting on the front, foil labels with imprinting on the back, foil labels with imprinting for an impression on the front and foil labels with imprinting for an impression on the back.

24. Use of the method according to claim 23 for the labeling of at least one of objects made of glass, objects made of plastic, objects made of a material that is opaque in at least some regions, objects made of a material that is transparent in at least some regions, bottles, glass bottles, plastic bottles, bottles made of polyethylene terephthalate (PET), non-transparent bottles and bottles made of a material that is transparent in at least some regions.
